(19) United States
(12) Patent Application Publication
(10) Pub. No.: US 2010/0089883 A1
(43) Pub. Date: Apr. 15, 2010

(54) WORKPIECE SPLITTING METHOD AND OBJECT PRODUCING METHOD

(75) Inventors: Kazushige UMETSU, Chino (JP); Yutaka YAMAZAKI, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/572,330

(22) Filed: Oct. 2, 2009

(30) Foreign Application Priority Data
Oct. 9, 2008 (JP) 2008-262953
Aug. 20, 2009 (JP) 2009-191297

(51) Int. Cl. B23K 26/38

(52) U.S. Cl. 219/121.72

(57) ABSTRACT

A workpiece splitting method includes mounting a protection sheet on a first surface of a workpiece to transmit a first laser beam through the sheet and protect the first surface; forming a modified region by multiple photon absorption inside the workpiece by concentrating, inside the workpiece, the first laser beam applied to the workpiece from a first surface side of the workpiece and transmitted through the protection sheet; and removing, from the first surface, a part of the protection sheet positioned on a line of intersection between the first surface and a splitting plane formed on the workpiece when splitting the workpiece at a portion where the modified region is formed, so as to split the workpiece at the modified region-formed portion.

### BACKGROUND

1. Technical Field

The present invention relates to a workpiece splitting method for splitting a workpiece and an object producing method.

2. Related Art

For example, JP-A-2008-116969 discloses a conventional method. In this method, first, there is provided a polarization plate on each of opposite outer surfaces of a liquid crystal glass substrate used for a liquid crystal panel. Next, using a separation cutter, a part of the polarization plate of at least one of the surfaces is cut off from the liquid crystal glass substrate in a belt-like shape to expose a part of the glass substrate in the belt-like shape. Then, a wheel cutter is used to form a splitting scribe groove along the exposed belt-like shaped region of the liquid crystal glass substrate. Consequently, the liquid crystal glass substrate is split along the scribe groove, so that a plurality of liquid crystal panels can be produced.

However, since the disclosed method uses the wheel cutter to form the scribe groove on the liquid crystal glass substrate, pressing force acts on the glass substrate upon formation of the scribe groove. Accordingly, after cutting off the a part of the polarization plate on a backside of the substrate corresponding to a scribe groove-forming position, there is nothing supporting the liquid crystal glass substrate in the position. In this case, the glass substrate can bend and crack in a position different from a predetermined intended splitting position.

### SUMMARY

An advantage of the invention is to provide a workpiece splitting method that suppresses pressing force acting on a workpiece when forming a splitting starting point on the workpiece.

In order to achieve the advantage, aspects and preferred features of the invention include following structures.

A workpiece splitting method according to a first aspect of the invention includes mounting a protection sheet on a first surface of a workpiece to transmit a first laser beam through the sheet and protect the first surface; forming a modified region by multiple photon absorption inside the workpiece by concentrating, inside the workpiece, the first laser beam applied to the workpiece from a first surface side of the workpiece and transmitted through the protection sheet; and removing, from the first surface, a part of the protection sheet positioned on a line of intersection between the first surface and a splitting plane formed on the workpiece when splitting the workpiece at a portion where the modified region is formed, so as to split the workpiece at the modified region-formed portion.

In the method of the first aspect, the first laser beam is transmitted through the protection sheet to be applied to the workpiece so as to form the modified region inside the workpiece. Thus, for example, unlike the method for physically forming the scribe groove on the workpiece, the method of the first aspect suppresses pressing force acting on the workpiece when forming a starting point for splitting on the workpiece.

A workpiece splitting method according to a second aspect of the invention includes mounting a protection sheet on a first surface of a workpiece to transmit a first laser beam through the sheet and protect the first surface; forming a scribe groove on the first surface of the workpiece by concentrating, on the first surface of the workpiece, the first laser beam applied to the workpiece from a first surface side of the workpiece and transmitted through the protection sheet; and removing a part of the protection sheet facing an opening portion of the scribe groove from the first surface of the workpiece, so as to split the workpiece at a scribe groove-formed portion.

In the method of the second aspect, the first laser beam is applied to the workpiece through the protection sheet to form the scribe groove on the first surface of the workpiece. Thus, for example, unlike the method for physically forming the scribe groove on the workpiece, the method of the second aspect suppresses pressing force acting on the workpiece when the starting point for splitting is formed on the workpiece.

Preferably, in the removal process, the a part of the protection sheet is ablated by applying a second laser beam absorbed by the protection sheet to the protection sheet.

In this manner, the pressing force acting on the workpiece can be suppressed more appropriately.

Preferably, the workpiece is a liquid crystal glass substrate used for a liquid crystal panel, and, in the protection sheet-mounting process, the protection sheet is a polarization plate having linear polarization characteristics.

In the above method, the polarization plate is present on an outer surface of a liquid crystal panel as a completed product. This can facilitate mounting of the polarization plate.

Preferably, in the modified region-forming process, the first laser beam has a same polarization plane as that of the polarization plate.

In this manner, since the first laser beam is not blocked by the polarization plate, the beam is transmitted through the plate, whereby the first laser beam can be applied to the liquid crystal glass substrate.

Preferably, the workpiece is a liquid crystal glass substrate including a first substrate, a second substrate whose one of opposite surfaces in a thickness direction of the second substrate faces one of opposite surfaces in a thickness direction of the first substrate, and a sealing member provided between the first and the second substrates to surround a liquid crystal-enclosed region; the protection sheet-mounting process includes mounting, as the protection sheet, a first polarization plate having linear polarization characteristics on an other surface of the opposite surfaces in the thickness direction of the first substrate as the first surface of the workpiece and mounting a second polarization plate having linear polarization characteristics on an other surface of the opposite surfaces in the thickness direction of the second substrate as a surface of the workpiece opposite to the first surface thereof; the modified region-forming process includes forming the modified region inside the first substrate by concentrating, inside the first substrate, the first laser beam applied to the first substrate from an other surface side of the opposite surfaces in the thickness direction of the first substrate and transmitted through the first polarization plate and forming the modified region inside the second substrate by concentrating, inside the second substrate, the first laser beam applied to the second substrate from an other surface side of the opposite surfaces in the thickness direction of the second substrate and transmitted through the second polarization plate.

In the above method, when forming the modified region inside the second substrate, the first laser beam applied from the second substrate side is transmitted through the second polarization plate to be applied to the second substrate. Accordingly, for example, unlike when the first laser beam is applied from the first substrate side to be transmitted through the first polarization plate and the first substrate so as to be concentrated inside the second substrate, the method can avoid transmission of the first laser beam having high energy density between the first and the second substrates. This can prevent first laser beam-induced damage to the liquid crystal and the like provided between the first and the second substrates.

Preferably, in the modified region-forming process, the modified regions of the first and the second substrates are formed in positions opposing each other in a thickness direction of the workpiece.

This can facilitate splitting of the workpiece in the thickness direction thereof.

Preferably, the workpiece is a liquid crystal glass substrate including a first substrate, a second substrate whose one of opposite surfaces in a thickness direction of the second substrate faces one of opposite surfaces in a thickness direction of the first substrate, and a sealing member provided between the first and the second substrates to surround a liquid crystal-enclosed region; the protection sheet-mounting process includes mounting, as the protection sheet, a first polarization plate having linear polarization characteristics on an other surface of the opposite surfaces in the thickness direction of the first substrate as the first surface of the workpiece; the modified region-forming process includes forming the modified region inside the first substrate by concentrating, inside the first substrate, the first laser beam applied to the first substrate from an other surface side of the opposite surfaces in the thickness direction of the first substrate and transmitted through the first polarization plate and forming the modified region inside the second substrate by concentrating, inside the second substrate, the first laser beam applied to the second substrate from the other surface side of the opposite surfaces in the thickness direction of the first substrate and transmitted through the first polarization plate and the first substrate.

In the above method, when forming the modified region inside the first substrate, the first laser beam is applied from the first substrate side to be transmitted through the first polarization plate so as to be concentrated inside the first substrate. Additionally, in the formation of the modified region inside the second substrate, the first laser beam is also applied from the first substrate side to be transmitted through the first polarization plate and the first substrate so as to be concentrated inside the second substrate. That is, when there are formed the respective modified regions inside the respective substrates, the first laser beam is applied to the workpiece from the same direction. Thus, for example, unlike when applying the first laser beam from the second substrate side to transmit the beam through the second polarization plate so as to concentrate the laser beam inside the second substrate, it is unnecessary to change the direction of the first laser beam to be applied to the workpiece.

Preferably, the sealing member transmits the first laser beam through the member.

In this manner, it can be prevented that the sealing member blocks the first laser beam transmitted through the first polarization plate and the first substrate when forming the modified region inside the second substrate.

An object producing method according to a third aspect of the invention includes splitting the workpiece by using the workpiece splitting method of the first aspect to obtain an object to be produced.

The method of the third aspect can facilitate production of the object to be produced.

### BRIEF DESCRIPTION OF THE DRAWINGS

The invention will be described with reference to the accompanying drawings, wherein like numbers reference like elements.

FIGS. 1A and 1B are schematic views showing each appearance of a liquid crystal glass substrate 1 in a first embodiment of the invention.

FIG. 2 is a side view of the liquid crystal glass substrate 1 used for illustration of a first process in the first embodiment.

FIGS. 3A to 3D are side views of the liquid crystal glass substrate 1 used for illustration of a second process in the embodiment.

FIG. 4 is a side view of the liquid crystal glass substrate 1 in a comparative example.

FIG. 5 is a side view of the liquid crystal glass substrate 1 in another comparative example.

FIG. 6 is a side view showing a modification of the liquid crystal glass substrate 1 in the second process in the embodiment.

FIGS. 7A to 7D are side views of the liquid crystal glass substrate 1 used for illustration of a third process in the embodiment.

FIGS. 8A and 8B are side views of the liquid crystal glass substrate 1 used for illustration of a fourth process in the embodiment.

FIGS. 9A to 9D are side views of a liquid crystal glass substrate 1 used for illustration of a second process in a second embodiment of the invention.

FIGS. 10A to 10D are side views of the liquid crystal glass substrate 1 used for illustration of a third process in the second embodiment.

FIGS. 11A and 11B are side views of the liquid crystal glass substrate 1 used for illustration of a fourth process in the second embodiment.

### DESCRIPTION OF EXEMPLARY EMBODIMENTS

Embodiments of the invention will be described with reference to the drawings.

### First Embodiment

In the first embodiment, a description will be given of details of processes for producing a plurality of liquid crystal panels by splitting a liquid crystal glass substrate used for a liquid crystal panel.

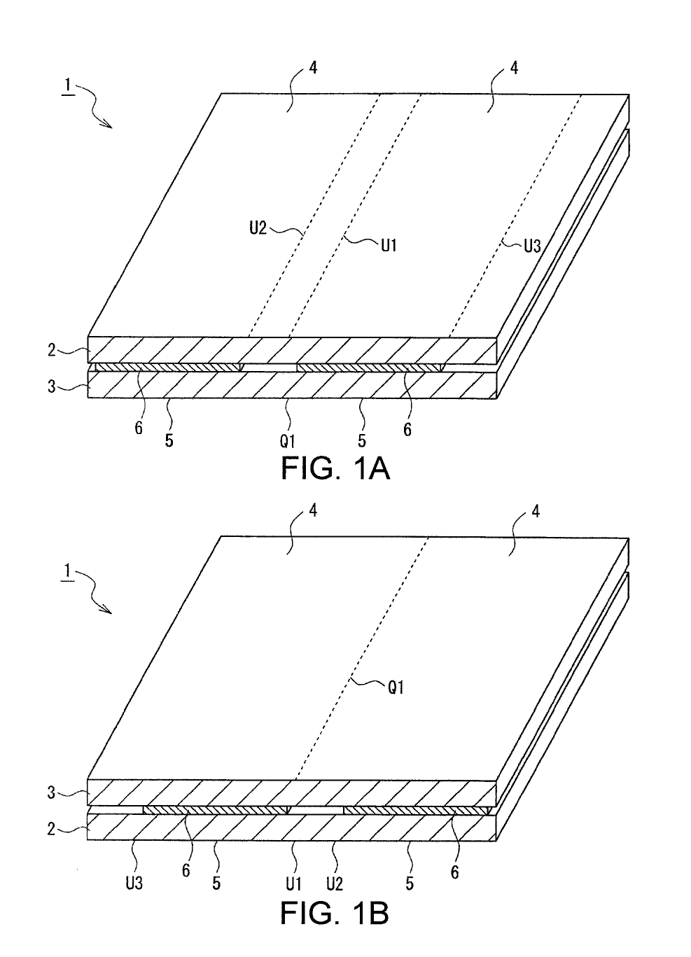

FIGS. 1A and 1B are perspective views showing each appearance of a liquid crystal glass substrate 1. FIG. 1A is a perspective view showing an appearance of the liquid crystal glass substrate 1 when viewed from a side where a TFT substrate 2 is located. FIG. 1B is a perspective view showing an appearance of the liquid crystal glass substrate 1 when viewed from a side where a color filter substrate 3 is located.

Preparation

First, the liquid crystal glass substrate 1 is prepared. As shown in FIG. 1A, the liquid crystal glass substrate 1 is formed by bonding together the TFT (thin film transistor) substrate 2 and the color filter substrate 3 both having a same rectangular shape. The TFT substrate 2 and the color filter substrate 3 are made of a translucent transparent material, such as borosilicate glass, AN-100 or OA-10. The substrates 2 and 3 are bonded together in such a manner that one of opposite surfaces in a thickness direction of the TFT substrate 2 faces one of opposite surfaces in a thickness direction of the color filter substrate 3.

An inside of the TFT substrate 2 is divided into two parts by an intended splitting line U1 of the TFT substrate 2. In this case, the intended splitting line U1 is a straight line that is set on an outer surface of the TFT substrate 2 to be extended in a direction orthogonal to a longitudinal direction of the TFT substrate 2. The outer surface of the TFT substrate 2 corresponds to an other surface of the opposite surfaces in the thickness direction of the TFT substrate 2. In this manner, inside the TFT substrate 2 are formed two TFT substrate cells 4 arranged in the longitudinal direction of the TFT substrate 2.

Additionally, as in FIG. 1B, an inside of the color filter substrate 3 is divided into two parts by an intended splitting line Q1 of the color filter substrate 3. The intended splitting line Q1 is a straight line that is set on an outer surface of the color filter substrate 3 to be extended in a direction orthogonal to a longitudinal direction of the color filter substrate 3. The intended splitting line Q1 becomes a straight line opposing the intended splitting line U1 in a thickness direction of the liquid crystal glass substrate 1 when the substrates 2 and 3 are bonded together. The outer surface of the color filter substrate 3 corresponds to an other surface of the opposite surfaces in the thickness direction of the color filter substrate 3. In this manner, inside the color filter substrate 3 are formed two color filter substrate cells 5 arranged in the longitudinal direction of the color filter substrate 3.

Accordingly, the TFT substrate 2 includes the two TFT substrate cells 4 arranged in the longitudinal direction thereof and the color filter substrate 3 includes the two color filter substrate cells 5 arranged in the longitudinal direction thereof. Consequently, inside the liquid crystal glass substrate 1 formed by bonding together the TFT substrate 2 and the color filter substrate 3 are formed two pairs of the TFT substrate cells 4 and the color filter substrate cells 5.

In addition, between each pair of the TFT substrate cell 4 and the color filter substrate cell 5 are provided liquid crystal (not shown) and a circular sealing member 6 surrounding a liquid crystal-enclosed region.

In the present embodiment, an example of the liquid crystal glass substrate 1 includes the liquid crystal enclosed between the each TFT substrate cell 4 and the each color filter substrate cell 5. However, there may be mentioned other examples of the glass substrate 1, such as a substrate with no liquid crystal enclosed.

Furthermore, at an end side of an outer surface of each of the TFT substrate cells 4 is provided an intended splitting line U2 or U3. The intended splitting lines U2 and U3 are straight lines extended in a direction parallel to the intended splitting line U1.

First Process

Next, a first process will be performed.

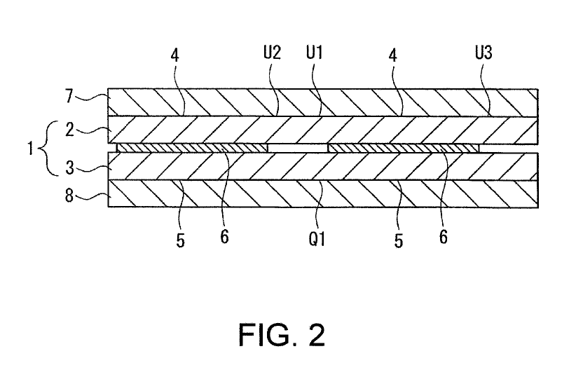

FIG. 2 is a side view of the liquid crystal glass substrate 1 used for illustration of the first process.

In the first process, first, as shown in FIG. 2, a TFT-side polarization plate 7 is mounted on the outer surface of the TFT substrate 2. The TFT-side polarization plate 7 is a sheet having linear polarization characteristics and transmits only light vibrating in a specific vibration direction through the plate 7. In addition, the TFT-side polarization plate 7 serves to protect the outer surface of the TFT substrate 2 and may be formed by absorption alignment of a dichromatic substance on a resin film, for example.

In the embodiment, the TFT-side polarization plate 7 has a same shape as that of the TFT substrate 2. The TFT-side polarization plate 7 is mounted on the TFT substrate 2 so as to entirely cover the outer surface of the TFT substrate 2.

The embodiment shows the example in which the TFT-side polarization plate 7 is mounted on the outer surface of the TFT substrate 2. However, other examples may be used. For example, instead of the TFT-side polarization plate 7, there may be used a different protection film that can transmit a below-described first laser beam through the sheet and can absorb a below-described second laser beam, such as a protection film made of PET (polyethylene terephthalate). Alternatively, while the TFT-side polarization plate 7 is mounted on the TFT substrate 2, the protection film may be mounted on an outer surface of the TFT-side polarization plate 7. The protection film to be mounted may be a single film or may include a plurality of films. The protection film mounted on the outer surface of the TFT-side polarization plate 7 is removable upon use of a liquid crystal panel 14.

Next, a color filter-side polarization plate 8 is mounted on the outer surface of the color filter substrate 3. The color filter-side polarization plate 8 is a sheet having linear polarization characteristics transmitting only light vibrating in a specific vibration direction. The color filter-side polarization plate 8 serves to protect the outer surface of the color filter substrate 3, and may be made of a same material as that of the TFT-side polarization plate 7.

Thus, in the embodiment, the TFT-side polarization plate 7 and the color filter-side polarization plate 8 are mounted onto the liquid crystal glass substrate 1 before splitting the glass substrate 1, thereby improving an entire strength of the glass substrate 1. This allows easy handling of the liquid crystal glass substrate 1 even if the substrate 1 has low strength because of a small thickness, a large size, or the like.

In addition, in the embodiment, before splitting the liquid crystal glass substrate 1, the TFT-side polarization plate 7 and the color filter-side polarization plate 8 each having a large size, respectively, are mounted on the respective outer surfaces of the liquid crystal glass substrate 1 at a same time. Accordingly, as compared to mounting of the TFT-side polarization plate 7 and the color filter-side polarization plate 8 onto each of liquid crystal glass substrates 1 split after splitting of the glass substrate 1, time and work for mounting the plates 7 and 8 thereon can be reduced.

Second Process

Next, a second process will be performed.

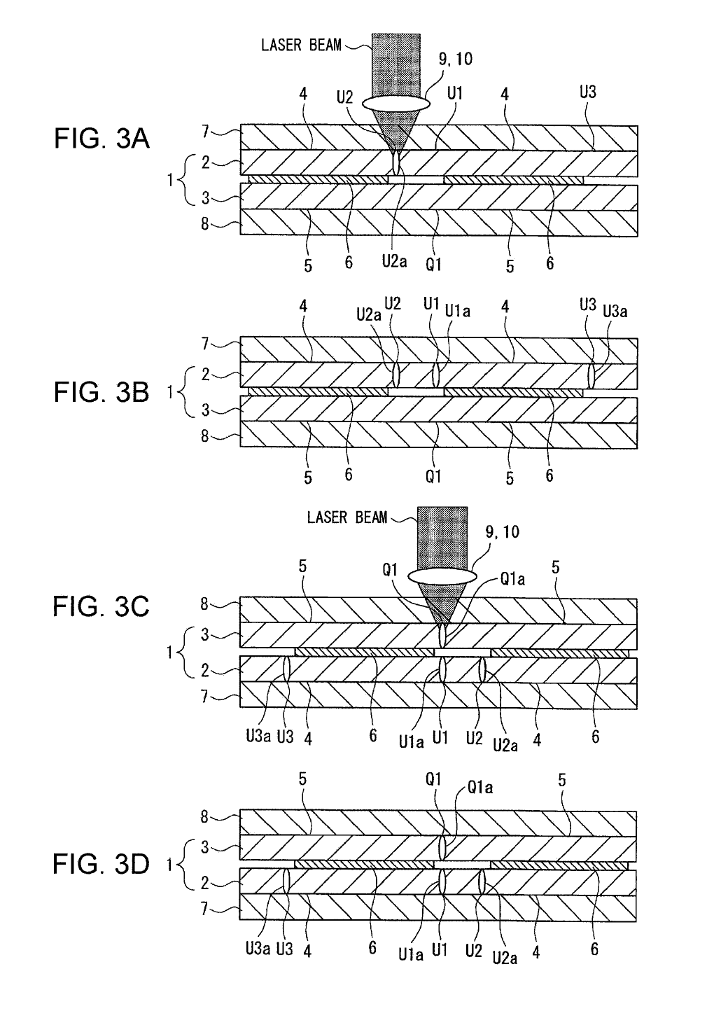

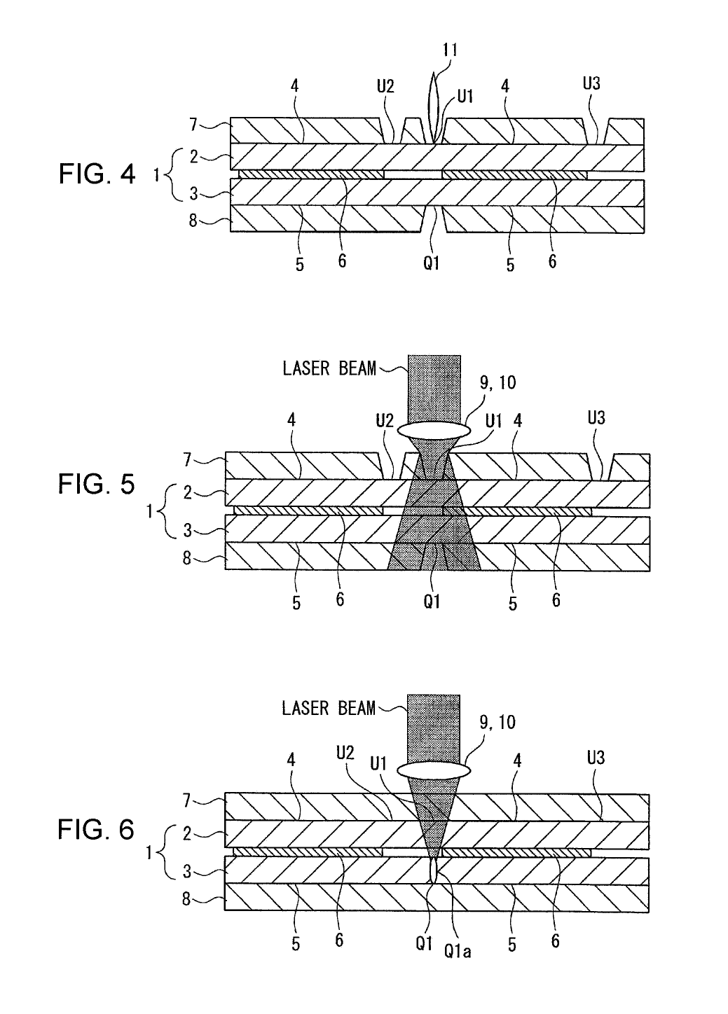

FIGS. 3A to 3D are side views showing the liquid crystal glass substrate 1 used for illustration of the second process. FIG. 3A is a side view illustrating a step for applying a first laser beam to the TFT substrate 2; FIG. 3B is a side view illustrating a step for forming a modified region in the TFT substrate 2; FIG. 3C is a side view illustrating a step for applying the first laser beam to the color filter substrate 3; and FIG. 3D is a side view illustrating a condition where a modified region is formed in the color filter substrate 3. FIGS. 4 and 5 are side views of the liquid crystal glass substrate 1 in comparative examples. FIG. 6 is a side view of the liquid crystal glass substrate 1 in a modification of the second process of the embodiment.

In the second process, first, as shown in FIG. 3A, the first laser beam is transmitted through the TFT-side polarization plate 7 to be concentrated inside the TFT substrate 2 along each of the intended splitting lines U1 to U3.

In that case, the first laser beam is a pulse laser beam that can be easily transmitted through the TFT-side polarization plate 7 and the color filter-side polarization plate 8 and can be easily absorbed by the TFT substrate 2 and the color filter substrate 3. For example, when the TFT substrate 2 and the color filter substrate 3 are made of glass OA-10 having a thickness of 100 μm, the first laser beam is a femto-second laser beam having a wavelength of 800 nm, a pulse repetition frequency of 5 kHz, a pulse width of 100 femto-seconds, a pulse energy of 3 μJ, a scanning speed of 1 mm per second, and a numerical aperture (N.A.) of 0.8. In addition, a vibration direction of the first laser beam is set to be the same as a vibration direction of light transmitted through the TFT-side polarization plate 7. That is, a direction of a polarization plane of the first laser beam is set to be the same as a direction of a polarization plane of the TFT-side polarization plate 7. Thereby, since the TFT-side polarization plate 7 does not block the first laser beam, the first laser beam is transmitted through the TFT-side polarization plate 7 to reach the TFT substrate 2.

In addition, a first laser beam application mechanism 9 is used for concentration of the first laser beam. The first laser beam application mechanism 9 is a mechanism that applies the first laser beam output from a first laser beam source (not shown) in a direction in which the laser beam is input from an outer surface side of the TFT substrate 2, namely from the surface side of the TFT substrate 2 having the TFT-side polarization plate 7, vertically with respect to the surface side, so as to concentrate the applied first laser beam inside the TFT substrate 2 by a lens 10. Next, the first laser beam application mechanism 9 concentrates the first laser beam on a portion along each of the intended splitting lines U1 to U3, and then, the first laser beam application mechanism 9 is moved from an end to an other end of the TFT substrate 2 along the each of the intended splitting lines U1 to U3. Thereby, the first laser beam concentrated portion is moved along the each of the intended splitting lines U1 to U3 from the end to the other end of the TFT substrate 2. As a result, as shown in FIG. 3B, there are formed modified regions U1a to U3a inside the TFT substrate 2 by multiple photon absorption along the each of the intended splitting lines U1 to U3. The modified regions U1a to U3a are regions where minute cracks occur.

As described above, in the first embodiment, the first laser beam is transmitted through the TFT-side polarization plate 7 to be applied to the TFT substrate 2 so as to form the modified regions U1a to U3a inside the TFT substrate 2. Accordingly, for example, unlike the method for physically forming a scribe groove, the method of the embodiment can suppress pressing force acting on the TFT substrate 2 when a starting point for splitting is formed on the TFT substrate 2. Consequently, the method of the embodiment can inhibit occurrence of cracks in positions different from the intended splitting lines U1 to U3 on the TFT substrate 2.

Meanwhile, as shown in FIG. 4, there is a method in which a part of the TFT-side polarization plate 7 is removed in a belt-like shape to form a scribe groove along an exposed belt-like shaped region of the TFT substrate 2 on the outer surface of the TFT substrate 2 by using a wheel cutter 11. In this method, upon formation of the scribe groove, pressing force acts on the TFT substrate 2. Accordingly, when a part of the color filter-side polarization plate 8 on a backside of the TFT substrate 2 in a scribe groove-forming position is cut off and then there is provided nothing reinforcing the TFT substrate 2 and the color filter substrate 3 in the position, the liquid crystal glass substrate 1 bends and cracks in positions different from the intended splitting lines U1 to U3.

In addition, in the embodiment, the first laser beam is applied before exposing the a part of the TFT substrate 2. Thereby, it can be prevented that the first laser beam is scattered by portions of the TFT-side polarization plate 7 remaining without being removed on opposite sides of the exposed part of the TFT substrate 2.

In contrast, FIG. 5 shows a method in which the first laser beam is applied after exposing the a part of the TFT substrate 2. In the method, the first laser beam is scattered when input to the portions of the TFT-side polarization plate 7 remaining without being removed on the opposite sides of the exposed part of the substrate 2. Thus, the first laser beam cannot be concentrated appropriately inside the TFT substrate 2, whereby the modified regions U1a to U3a cannot be formed inside the TFT substrate 2 along the intended splitting lines U1 to U3.

Next, as shown in FIG. 3C, the first laser beam is transmitted through the color filter-side polarization plate 8 to be concentrated inside the color filter substrate 3 along the intended splitting line Q1.

In this case, the vibration direction of the first laser beam is set to be the same as a vibration direction of light transmitted through the color filter-side polarization plate 8, similarly to when the first laser beam is applied to the TFT substrate 2. That is, the direction of the polarization plane of the first laser beam is set to be the same as a direction of a polarization plane of the color filter-side polarization plate 8. Thereby, since the color filter-side polarization plate 8 does not block the first laser beam, the first laser beam is transmitted through the plate 8 to reach the color filter substrate 3.

The first laser beam is applied by the first laser beam application mechanism 9. The first laser beam application mechanism 9 is used by changing a direction of the first laser beam applied to the liquid crystal glass substrate 1. Specifically, the first laser beam application mechanism 9 applies the first laser beam output from the first laser beam source in a direction in which the laser beam is input from an outer surface side of the color filter substrate 3, namely from the surface side of the substrate 3 having the color filter-side polarization plate 8, vertically with respect to the surface side, so as to concentrate the applied first laser beam inside the color filter substrate 3 by the lens 10. Next, the first laser beam application mechanism 9 concentrates the laser beam on a portion positioned along the intended splitting line Q1 inside the color filter substrate 3 and is moved along the intended splitting line Q1 from an end to an other end of the color filter substrate 3. Thereby, the first laser beam concentrated portion is moved along the intended splitting line Q1 from the end to the other end of the color filter substrate 3. Thus, as shown in FIG. 3D, inside the color filter substrate 3 is formed a modified region Q1a by multiple photon absorption along the intended splitting line Q1. As a result, the modified region U1a of the TFT substrate 2 and the modified region Q1a of the color filter substrate 3 are formed in positions opposing each other in the thickness direction of the liquid crystal glass substrate 1.

As described above, in the embodiment, when forming the modified region inside the color filter substrate 3, the first laser beam is applied from the side of the color filter substrate 3 and transmitted through the second polarization plate to be applied to the color filter substrate 3. Accordingly, for example, unlike the method in which the first laser beam applied from the side of the TFT substrate 2 is transmitted through the TFT substrate 2 to be concentrated inside the color filter substrate 3, it can be avoided that the first laser beam having high energy density is transmitted between the TFT substrate 2 and the color filter substrate 3. Thereby, it can be prevented that the first laser beam damages element members provided between the TFT substrate 2 and the color filter substrate 3, such as the liquid crystal and the sealing member 6.

Additionally, in the embodiment, the modified regions of the TFT substrate 2 and the color filter substrate 3 are formed opposing each other in the thickness direction of the liquid crystal glass substrate 1, so that the liquid crystal glass substrate 1 can be easily split in the thickness direction thereof.

In the example of the embodiment, the first laser beam is applied to the color filter substrate 3 from the outer surface side of the color filter substrate 3, and the first laser beam is transmitted through the color filter-side polarization plate 8 to be concentrated inside the color filter substrate 3. However, other methods may be employed. For example, as shown in FIG. 6, the first laser beam may be applied to the color filter substrate 3 from the outer surface side of the TFT substrate 2 to be transmitted through the TFT-side polarization plate 7 and the TFT substrate 2 so as to be concentrated inside the color filter substrate 3. In that case, in order to form the modified region inside the TFT substrate 2, the first laser beam is applied from the side of the TFT substrate 2 and transmitted through the TFT-side polarization plate 7 to be concentrated inside the TFT substrate 2. Additionally, in formation of the modified region inside the color filter substrate 3, the first laser beam is applied from the side of TFT substrate 2 and transmitted through the TFT-side polarization plate 7 and the TFT substrate 2 to be concentrated inside the color filter substrate 3. Accordingly, the direction of the first laser beam applied to the liquid crystal glass substrate 1 is the same when the modified region is formed inside the TFT substrate 2 and the color filter substrate 3, respectively. Thus, it is unnecessary to change the direction of the first laser beam applied to the liquid crystal glass substrate 1.

Furthermore, in order to form the modified region inside the color filter substrate 3, when the first laser beam is applied from the side of the TFT substrate 2 to be transmitted through the TFT-side polarization plate 7 and the TFT substrate 2 so as to be concentrated inside the color filter substrate 3, the sealing member 6 may be made of a material that transmits the first laser beam therethrough. Thereby, it can be prevented that the sealing member 6 blocks the first laser beam transmitted through the TFT-side polarization plate 7 and the TFT substrate 2 when forming the modified region inside the color filter substrate 3.

Third Process

Next, a third process will be performed.

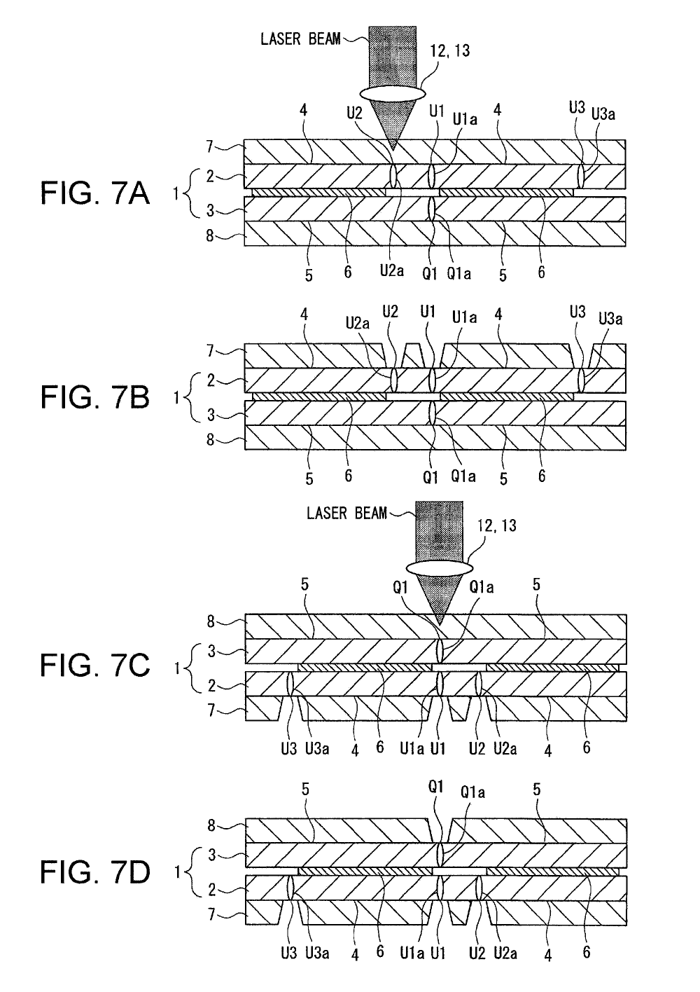

FIGS. 7A to 7D are side views showing the liquid crystal glass substrate 1 used for illustration of the third process. FIG. 7A is a side view illustrating a step for applying a second laser beam to the TFT-side polarization plate 7; FIG. 7B is a side view illustrating a condition where a part of the TFT side polarization plate 7 is ablated; FIG. 7C is a side view illustrating a step for applying the second laser beam to the color filter-side polarization plate 8; and FIG. 7D is a side view illustrating a condition where a part of the color filter-side polarization plate 8 is ablated.

In the third process, first, as shown in FIG. 7A, the second laser beam is concentrated inside the TFT side polarization plate 7 along each of the intended splitting lines U1 to U3.

In the embodiment, the second laser beam is a pulse laser beam that can be easily absorbed by the TFT-side polarization plate 7 and the color filter-side polarization plate 8. For example, when the TFT-side polarization plate 7 and the color filter-side polarization plate 8 are made of a resin material and have a thickness of 200 μm, the second laser beam may be a third-order harmonic of YAG laser having a wavelength of 355 nm, a pulse repetition frequency of 50 kHz, a pulse width of 60 nanoseconds, a pulse energy of 50 μJ, a scanning speed of 50 mm per second, a lens focal distance of 40 mm, and a numerical aperture (N.A.) of 0.8.

In addition, the second laser beam is concentrated by a second laser beam application mechanism 12. The second laser beam application mechanism 12 applies the second laser beam output from a second laser beam source (not shown) in a direction in which the laser beam is input from the outer surface side of the TFT-side polarization plate 7, namely from the surface of the plate 7 opposite to the surface thereof contacted with the TFT substrate 2, vertically with respect to the opposite side surface, so as to concentrate the second laser beam inside the TFT-side polarization plate 7. Then, the second laser beam application mechanism 12 concentrates the second laser beam on a portion of the TFT-side polarization plate 7 opposing each of the intended splitting lines U1 to U3 by a lens 13 and is moved from an end from to an other end of the TFT-side polarization plate 7 along the each of the intended splitting lines U1 to U3. Thereby, the second laser beam concentrated portion is moved along the each of the intended splitting lines U1 to U3 from the end to the other end of the TFT substrate 2. As a result, as shown in FIG. 7B, a part of the TFT-side polarization plate 7 is ablated in a belt-like shape along the each of the intended splitting lines U1 to U3. In other words, when the liquid crystal glass substrate 1 is split at the portions having the modified regions formed by the concentration of the first laser beam, a portion of the TFT-side polarization plate 7 facing each of the intended splitting lines U1 to U3 where a splitting plane formed on the TFT substrate 2 intersects with the outer surface of the TFT substrate 2 is removed from the outer surface of the TFT substrate 2.

The embodiment has exemplified the method in which the second laser beam is concentrated inside the TFT-side polarization plate 7 to ablate the a part of the plate 7 in the belt-like shape along the each of the intended splitting lines U1 to U3. However, other alternative methods may be employed. For example, using a separation cutter that can cut the TFT-side polarization plate 7, the a part of the TFT-side polarization plate 7 may be cut off in the belt-like shape along the each of the intended splitting lines U1 to U3.

Next, as shown in FIG. 7C, the second laser beam is applied to the color filter-side polarization plate 8 along the intended splitting line Q1.

The second laser beam is applied by the second laser beam application mechanism 12. The second laser beam application mechanism 12 is used by changing a direction of the second laser beam applied to the liquid crystal glass substrate 1. Specifically, the second laser beam application mechanism 12 applies the second laser beam output from the second laser beam source in a direction in which the laser beam is input from the outer surface side of the color filter-side polarization plate 8, namely from the surface of the plate 8 opposite to the surface thereof contacted with the color filter substrate 3, vertically with respect to the opposite side surface, so as to concentrate the applied second laser beam inside the TFT-side polarization plate 7 by the lens 13. The second laser beam application mechanism 12 concentrates the laser beam on a portion of the color filter-side polarization plate 8 facing the intended splitting line Q1 and is moved along the intended splitting line Q1 from an end to an other end of the color filter-side polarization plate 8. The second laser beam concentrated portion is moved along the intended splitting line Q1 from the end to the other end of the color filter-side polarization plate 8. Then, as shown in FIG. 7D, a part of the color filter-side polarization plate 8 is ablated in a belt-like shape along the intended splitting line Q1. Consequently, the modified region U1a of the TFT substrate 2 and the modified region Q1a of the color filter substrate 3 are formed in positions opposing each other in the thickness direction of the liquid crystal glass substrate 1. In other words, when the liquid crystal glass substrate 1 is split at the portions having the modified regions formed by concentration of the first laser beam, a portion of the color filter-side polarization plate 8 facing the intended splitting line Q1 where a splitting plane formed on the color filter substrate 3 intersects with the outer surface of the color filter substrate 3 is removed from the outer surface of the color filter substrate 3.

Fourth Process

Next a fourth process will be performed.

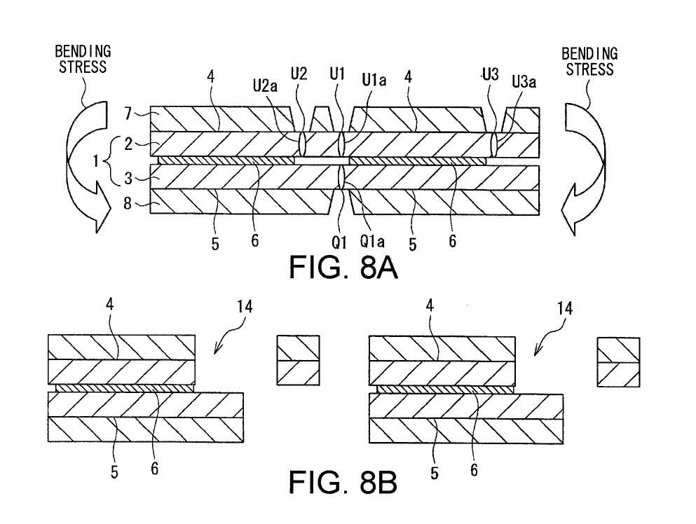

FIGS. 8A and 8B are side views showing the liquid crystal glass substrate 1 used for illustration of the fourth process. FIG. 8A is a side view illustrating a step for applying a load to the liquid crystal glass substrate 1, and FIG. 8B is a side view illustrating a condition where the liquid crystal glass substrate 1 has been split.

In the fourth process, as shown in FIG. 8A, a load is applied to the liquid crystal glass substrate 1.

In this case, for example, the load is applied to the liquid crystal glass substrate 1 by applying bending stress or shearing stress to the liquid crystal glass substrate 1 along the intended splitting lines U1 to U3 of the substrate 1 or by causing thermal stress on the liquid crystal glass substrate 1 by applying a temperature difference to the glass substrate 1. Thereby, as shown in FIG. 8B, the liquid crystal glass substrate 1 is split along the modified regions U1a to U3a and Q1a to obtain two liquid crystal panels 14. Each of the liquid crystal panels 14 includes the a pair of a TFT substrate cell 4 and a color filter substrate cell 5.

In the liquid crystal panel 14 thus obtained, the TFT-side polarization plate 7 and the color filter-side polarization plate 8, respectively, are mounted on approximately entirely on the respective outer surfaces of the TFT substrate cell 4 and the color filter substrate cell 5. This can prevent a foreign material from adhering on the liquid crystal panel 14 upon splitting of the panel 14.

It can also be prevented that the outer surface of the liquid crystal panel 14 is damaged during transfer of the liquid crystal panel 14. Consequently, the prevention of damage to the liquid crystal panel 14 can prevent reduction in surface strength (namely, bending strength) of the liquid crystal panel 14 due to the damage.

In the present embodiment, the liquid crystal glass substrate 1 shown in FIG. 2 corresponds to the workpiece. Additionally, the TFT-side polarization plate 7 of FIG. 2 corresponds to the protection sheet, the polarization plate, and the first polarization plate. The TFT substrate 2 and the color filter substrate 3 shown in FIG. 2, respectively, correspond to the first substrate and the second substrate, respectively. The color filter-side polarization plate 8 of FIG. 2 corresponds to the second polarization plate.

The embodiment has described the an application example by production of the liquid crystal panel 14. However, the embodiment can be applied to obtain other objects to be produced. For example, the method of the embodiment may be applied to produce display panels for apparatuses such as organic EL (electro luminescence) displays, data copiers, light bulbs, and touch panels. Furthermore, for example, the method of the embodiment may be applied to produce MEMS (micro electro mechanical systems), such as flow-path structures used in inkjet heads and micro total analysis systems. In the MEMS, mechanical element components, sensors, actuators, and electronic circuits are integrated on a single silicon or glass substrate, a single organic member, or the like.

### Second Embodiment

Next, a second embodiment of the invention will be described with reference to the drawings.

In the second embodiment, same structures as those in the first embodiment will be given the same reference numerals in the description below.

Unlike the first embodiment, the second embodiment forms scribe grooves U1b to U3b and Q1b, instead of the modified regions U1a to U3a, as splitting starting points for splitting the liquid crystal glass substrate 1 along the intended splitting lines U1 to U3 and Q1 on the outer surface of the liquid crystal glass substrate 1.

Specifically, the first process of the second embodiment is the same as that of the first embodiment, but second through fourth processes of the second embodiment are different from those of the first embodiment.

Second Process

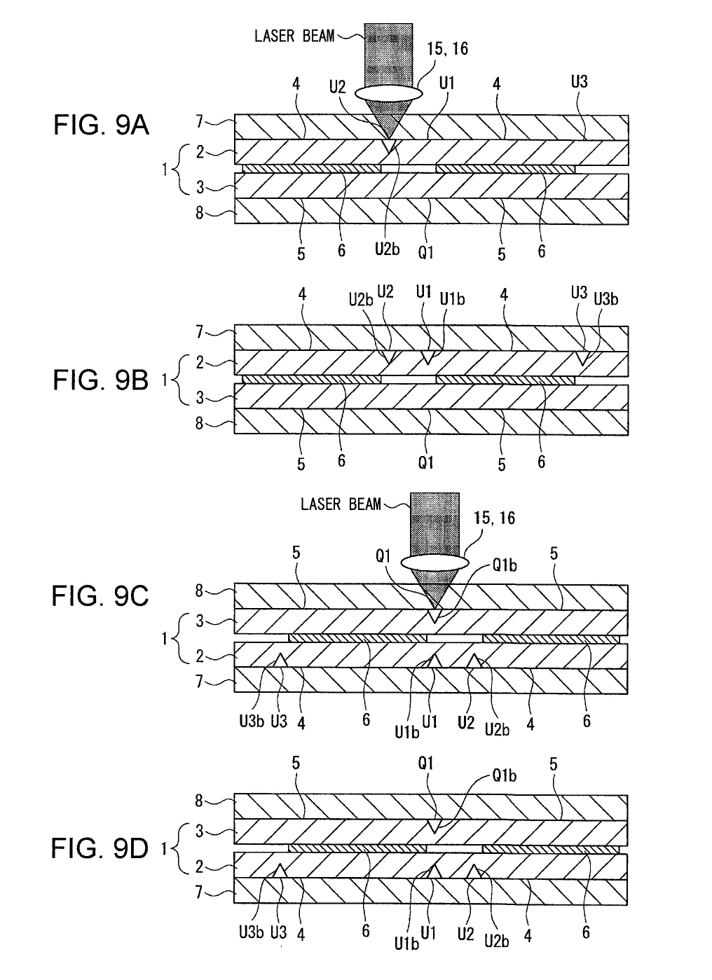

FIGS. 9A to 9D are side views showing the liquid crystal glass substrate 1 used for illustration of the second process in the second embodiment. FIG. 9A is a side view illustrating a step for applying the first laser beam to the TFT substrate 2; FIG. 9B is a side view illustrating a condition where scribe grooves have been formed in the TFT substrate 2; FIG. 9C is a side view illustrating a step for applying the first laser beam to the color filter substrate 3; and FIG. 9D is a side view illustrating a condition where a scribe groove has been formed in the color filter substrate 3.

In the second process, first, as shown in FIG. 9A, the first laser beam is transmitted through the TFT-side polarization plate 7 to be concentrated on the outer surface of the TFT substrate 2 along each of the intended splitting lines U1 to U3.

In this case, the vibration direction of the first laser beam is set to be the same as the vibration direction of light transmitted through the TFT-side polarization plate 7. That is, the direction of the polarization plane of the first laser beam is set to be the same as the direction of the polarization plane of the TFT-side polarization plate 7. Thereby, since the TFT-side polarization plate 7 does not block the first laser beam, the first laser beam is transmitted through the plate 7 to reach the TFT substrate 2.

The first laser beam is applied by a third laser beam application mechanism 15. The third laser beam application mechanism 15 applies the first laser beam output from a third laser beam source (not shown) in a direction in which the laser beam is input from the outer surface side of the TFT substrate 2, namely from the surface side of the substrate 2 having the TFT-side polarization plate 7, vertically with respect to the surface side, so as to concentrate the applied first laser beam on the outer surface of the TFT substrate 2 by a lens 16. Next, the third laser beam application mechanism 15 concentrates the laser beam on a portion along each of the intended splitting lines U1 to U3 on the TFT substrate 2 and is moved along the each of the intended splitting lines U1 to U3 from the end to the other end of the TFT substrate 2. Thereby, the first laser beam concentrated portion is moved along the each of the intended splitting lines U1 to U3 Q1 from the end to the other end of the TFT substrate 2. Then, as shown in FIG. 9B, on the outer surface of the TFT substrate 2 is formed a minute crack region (a removing region) along each of the intended splitting lines U1 to U3. In this manner, a minute crack is provided on the outer surface of the TFT substrate 2 to form the scribe grooves U1b to U3b. In each of the scribe grooves U1b to U3b, a region up to a depth of approximately 10 microns from the outer surface of the TFT substrate 2 is smashed into sub-micron sized particles to be stuck between the TFT substrate 2 and the TFT-side polarization plate 7.

As described above, in the present embodiment, the first laser beam is transmitted through the TFT-side polarization plate 7 to be applied to the TFT substrate 2 to form the scribe grooves U1b to U3b on the outer surface of the TFT substrate 2. Accordingly, for example, unlike the method for physically forming scribe grooves, the embodiment can suppress pressing force acting on the TFT substrate 2 when a starting point for splitting is formed on the TFT substrate 2, thereby inhibiting the TFT substrate 2 from being split in positions different from the intended splitting lines U1 to U3.

Next, as shown in FIG. 9C, the first laser beam is transmitted through the color filter-side polarization plate 8 to be concentrated on the outer surface of the color filter substrate 3 along the intended splitting line Q1.

The vibration direction of the first laser beam is set to be the same as the vibration direction of the light transmitted through the color filter-side polarization plate 8, as in the case of the first laser beam applied to the TFT substrate 2. That is, the direction of the polarization plane of the first laser beam is set to be the same as that of the polarization plane of the color filter-side polarization plate 8. Thereby, since the first laser beam is not blocked by the color filter-side polarization plate 8, the first laser beam is transmitted through the plate 8 to reach the color filter substrate 3.

The first laser beam is applied by the third laser beam application mechanism 15. The third laser beam application mechanism 15 is used by changing the direction of the first laser beam applied to the liquid crystal glass substrate 1. Specifically, the third laser beam application mechanism 15 applies the first laser beam output from the third laser beam source in a direction in which the laser beam is input from the outer surface side of the color filter substrate 3, namely from the surface side of the substrate 3 having the color filter-side polarization plate 8, vertically with respect to the surface side, so as to concentrate the applied first laser beam on the outer surface of the color filter substrate 3 by the lens 16. Next, the third laser beam application mechanism 15 concentrates the laser beam on a portion along the intended splitting line Q1 on the color filter substrate 3 and is moved along the intended splitting line Q1 from the end to the other end of the color filter substrate 3. Thereby, the first laser beam concentrated portion is moved along the intended splitting line Q1 from the end to the other end of the color filter substrate 3. Then, as shown in FIG. 9D, on the outer surface of the color filter substrate 3 is formed a minute crack region (a removing region) along the intended splitting line Q1. In this manner, a minute crack is provided on the outer surface of the color filter substrate 3 to form the scribe groove Q1b.

Third Process

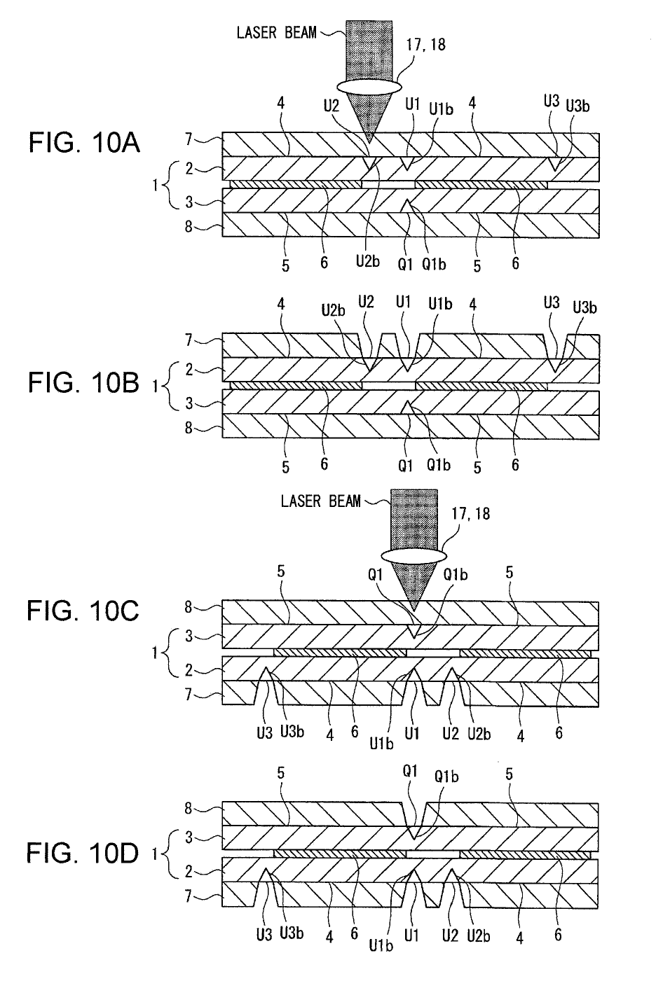

FIGS. 10A to 10D are side views showing the liquid crystal glass substrate 1 used for illustration of a third process in the second embodiment. FIG. 10A is a side view illustrating a step for applying the second laser beam to the TFT-side polarization plate 7; FIG. 10B is a side view illustrating a condition where a part of the TFT-side polarization plate 7 has been ablated; FIG. 10C is a side view illustrating a step for applying the second laser beam to the color filter-side polarization plate 8; and FIG. 10D is a side view illustrating a condition where a part of the color filter-side polarization plate 8 has been ablated.

In the third process, as shown in FIG. 10A, the second laser beam is concentrated inside the TFT-side polarization plate 7 along each of the intended splitting lines U1 to U3.

The second laser beam is concentrated by a fourth laser beam application mechanism 17. The fourth laser beam application mechanism 17 applies the second laser beam output from a fourth laser beam source (not shown) in a direction in which the laser beam is input from the outer surface side of the TFT-side polarization plate 7, namely from the surface of the plate 7 opposite to the surface thereof contacted with the TFT substrate 2, vertically with respect to the opposite surface side, so as to concentrate the applied second laser beam inside the TFT-side polarization plate 7 by a lens 18. Then, the fourth laser beam application mechanism 17 concentrates the laser beam on a portion of the TFT-side polarization plate 7 facing each of the intended splitting lines U1 to U3 and is moved from the end to the other end of the TFT-side polarization plate 7 along the each of the intended splitting lines U1 to U3. Thereby, the second laser beam concentrated portion is moved along the each of the intended splitting lines U1 to U3 from the end to the other end of the TFT-side polarization plate 7. Then, as shown in FIG. 10B, the a part of the TFT-side polarization plate 7 is ablated in a belt-like shape along the each of the intended splitting lines U1 to U3. In other words, the portion of the TFT-side polarization plate 7 facing an opening portion of each of the scribe grooves U1b to U3b is removed from the outer surface of the TFT substrate 2.

Next, as shown in FIG. 10C, the second laser beam is concentrated on the color filter-side polarization plate 8 along the intended splitting line Q1.

The second laser beam is concentrated by the fourth laser beam application mechanism 17. The fourth laser beam application mechanism 17 is used by changing the direction of the second laser beam applied to the liquid crystal glass substrate 1. Specifically, the fourth laser beam application mechanism 17 applies the second laser beam output from the fourth laser beam source in a direction in which the laser beam is input from the outer surface side of the color filter-side polarization plate 8, namely from the surface of the plate 8 opposite to the surface thereof contacted with the color filter substrate 3, vertically with respect to the opposite side surface, so as to concentrate the applied second laser beam inside the color filter-side polarization plate 8 by the lens 18. Then, the fourth laser beam application mechanism 17 concentrates the laser beam on a portion of the color filter-side polarization plate 8 facing the intended splitting line Q1 and is moved along the intended splitting line Q1 from the end to the other end of the color filter-side polarization plate 8. Thereby, the second laser beam concentrated portion is moved along the intended splitting line Q1 from the end to the other end of the color filter-side polarization plate 8. Thus, as shown in FIG. 10D, the a part of the color filter-side polarization plate 8 is ablated in a belt-like shape along the intended splitting line Q1. In other words, the portion of the color filter-side polarization plate 8 facing the opening portion of the scribe groove Q1b is removed from the outer surface of the color filter substrate 3.

Fourth Process

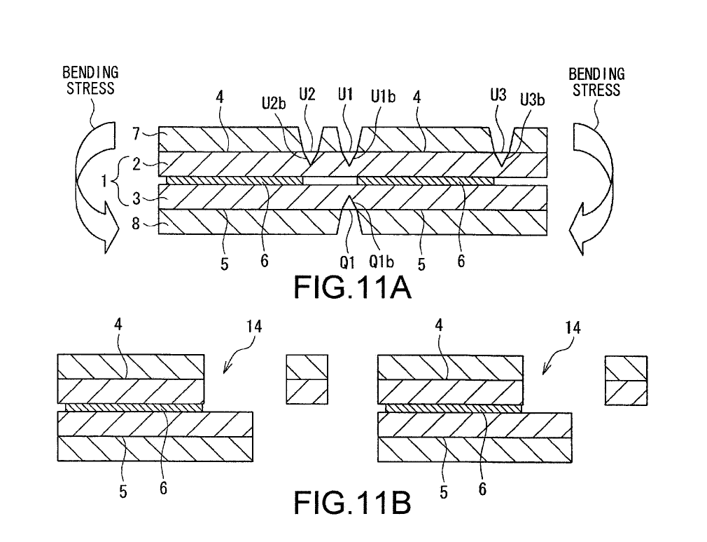

FIGS. 11A and 11B are side views showing the liquid crystal glass substrate 1 used for illustration of a fourth process in the second embodiment. FIG. 11A is a side view illustrating a step for applying a load to the liquid crystal glass substrate 1, and FIG. 11B is a side view illustrating a condition where the liquid crystal glass substrate 1 has been split.

In the fourth process, as shown in FIG. 11A, a load is applied to the liquid crystal glass substrate 1.

In this case, for example, the load is applied to the liquid crystal glass substrate 1 by applying bending stress or shearing stress to the liquid crystal glass substrate 1 along the intended splitting lines U1 to U3 of the glass substrate 1 or by causing thermal stress on the liquid crystal glass substrate 1 by applying a temperature difference to the glass substrate 1. Thereby, as shown in FIG. 11B, the liquid crystal glass substrate 1 is split along the scribe grooves U1b to U3b and Q1b to obtain two liquid crystal panels 14.

In the liquid crystal panel 14 thus obtained, the TFT-side polarization plate 7 and the color filter-side polarization plate 8, respectively, are mounted on approximately entirely on the respective outer surfaces of the TFT substrate cell 4 and the color filter substrate cell 5. This can prevent the adherence of a foreign material to the liquid crystal panel 14 upon splitting of the panel 14.

It can also be prevented that the outer surface of the liquid crystal panel 14 is damaged during transfer of the liquid crystal panel 14. Consequently, the prevention of damage to the liquid crystal panel 14 can prevent reduction in the surface strength (the bending strength) of the liquid crystal panel 14 due to the damage.

In the present embodiment, the liquid crystal glass substrate 1 shown in FIG. 9 corresponds to the workpiece. Additionally, the TFT-side polarization plate 7 of FIG. 9 corresponds to the protection sheet, the polarization plate, and the first polarization plate. The TFT substrate 2 and the color filter substrate 3, respectively, shown in FIG. 9 correspond to the first substrate and the second substrate, respectively. The color filter-side polarization plate 8 of FIG. 9 corresponds to the second polarization plate.

The entire disclosure of Japanese Patent Application No. 2009-191297, filed Aug. 20, 2009 is expressly incorporated by reference herein.

What is claimed is:

1. A workpiece splitting method, comprising:
(a) mounting a protection sheet on a first surface of a workpiece to transmit a first laser beam through the sheet and protect the first surface;
(b) forming a modified region by multiple photon absorption inside the workpiece by concentrating, inside the workpiece, the first laser beam applied to the workpiece from a first surface side of the workpiece and transmitted through the protection sheet; and
(c) removing, from the first surface, a part of the protection sheet positioned on a line of intersection between the first surface and a splitting plane formed on the workpiece when splitting the workpiece at a portion where the modified region is formed, so as to split the workpiece at the modified region-formed portion.

2. A workpiece splitting method, comprising:
(d) mounting a protection sheet on a first surface of a workpiece to transmit a first laser beam through the sheet and protect the first surface;
(e) forming a scribe groove on the first surface of the workpiece by concentrating, on the first surface of the workpiece, the first laser beam applied to the workpiece from a first surface side of the workpiece and transmitted through the protection sheet; and
(f) removing a part of the protection sheet facing an opening portion of the scribe groove from the first surface of the workpiece, so as to split the workpiece at a scribe groove-formed portion.

3. The workpiece splitting method according to claim 1, wherein, in step (c), the a part of the protection sheet is ablated by applying a second laser beam absorbed by the protection sheet to the protection sheet.

4. The workpiece splitting method according to claim 1, wherein the workpiece is a liquid crystal glass substrate used for a liquid crystal panel, and, in step (a), the protection sheet is a polarization plate having linear polarization characteristics.

5. The workpiece splitting method according to claim 4, wherein, in step (b), the first laser beam has a same polarization plane as that of the polarization plate.

6. The workpiece splitting method according to claim 1, wherein: the workpiece is a liquid crystal glass substrate including a first substrate, a second substrate whose one of opposite surfaces in a thickness direction of the second substrate faces one of opposite surfaces in a thickness direction of the first substrate, and a sealing member provided between the first and the second substrates to surround a liquid crystal-enclosed region; step (a) includes mounting, as the protection sheet, a first polarization plate having linear polarization characteristics on an other surface of the opposite surfaces in the thickness direction of the first substrate as the first surface of the workpiece and mounting a second polarization plate having linear polarization characteristics on an other surface of the opposite surfaces in the thickness direction of the second substrate as a surface of the workpiece opposite to the first surface thereof; and step (b) includes forming the modified region inside the first substrate by concentrating, inside the first substrate, the first laser beam applied to the first substrate from an other surface side of the opposite surfaces in the thickness direction of the first substrate and transmitted through the first polarization plate and forming the modified region inside the second substrate by concentrating, inside the second substrate, the first laser beam applied to the second substrate from an other surface side of the opposite surfaces in the thickness direction of the second substrate and transmitted through the second polarization plate.

7. The workpiece splitting method according to claim 6, wherein, in step (b), the modified regions of the first and the second substrates are formed in positions opposing each other in a thickness direction of the workpiece.

8. The workpiece splitting method according to claim 1, wherein: the workpiece is a liquid crystal glass substrate including a first substrate, a second substrate whose one of opposite surfaces in a thickness direction of the second substrate faces one of opposite surfaces in a thickness direction of the first substrate, and a sealing member provided between the first and the second substrates to surround a liquid crystal-enclosed region; step (a) includes mounting, as the protection sheet, a first polarization plate having linear polarization characteristics on an other surface of the opposite surfaces in the thickness direction of the first substrate as the first surface of the workpiece; and step (b) includes forming the modified region inside the first substrate by concentrating, inside the first substrate, the first laser beam applied to the first substrate from an other surface side of the opposite surfaces in the thickness direction of the first substrate and transmitted through the first polarization plate and forming the modified region inside the second substrate by concentrating, inside the second substrate, the first laser beam applied to the second substrate from the other surface side of the opposite surfaces in the thickness direction of the first substrate and transmitted through the first polarization plate and the first substrate.

9. The workpiece splitting method according to claim 8, wherein the sealing member transmits the first laser beam through the member.

10. An object producing method including splitting the workpiece by using the workpiece splitting method of claim 1 to obtain an object to be produced.
